(19) United States
(12) Patent Application Publication
(10) Pub. No.: US 2009/0293746 A1
(43) Pub. Date: Dec. 3, 2009

(54) METHOD FOR OPERATING A PRINTING PRESS

(76) Inventors: Stephan Schultze, Lohr am Main (DE); Holger Schnabel, Rottendorf (DE)

Correspondence Address: Striker, Striker & Stenby, 103 East Neck Road, Huntington, NY, 11743, US

(21) Appl. No.: 12/099,935

(22) Filed: Apr. 9, 2008

(30) Foreign Application Priority Data
Apr. 10, 2007 (DE) 10 2007 017 095.7

(51) Int. Cl. B41F 13/24; B41F 33/00

(52) U.S. Cl. 101/248; 101/484

(57) ABSTRACT

The present invention relates to a method for operating a printing press (2), with which a control for register and a control for at least one printing press module of the printing press (2) are carried out jointly by an automation device (36). The present invention also relates to an automation device (36) that is designed to interact with a printing press (2), and in which functionalities for controlling at least one printing press module and for register control are integrated.

The present invention relates to a method for operating a printing press, an automation device and a printing press, and a computer program, and a computer program product.

### RELATED ART

In the field of printing presses, in particular with gravure presses, in-line flexo presses or machines or commercial printing presses, colors must be printed directly one over the other in order to obtain a good printing result. If register deviations occur on the longitudinal register or the color register, a register control may typically eliminate this register deviation. Control strategies that statically and dynamically decouple an adjustment motion are required for this. Using these control strategies, setpoint values are calculated for a control that is decoupled to the greatest extent possible. Up to now, a calculation of this type has been performed using a standalone register regulation device that calculates—based on register deviations—manipulated variables for compensating for the register error as quickly as possible for continuous materials. A continuous material to be printed on may be paper, textiles, cardboard, foil, rubber, and, therefore, any flat material.

Typically, the register control device and the machine control are carried out separately using motion control/SPS, that is, different devices are provided. This results in a great deal of communication and many support points between the register control device and the machine control. Normally, process data are transferred from the machine control to the register control device, and register control data are transferred from the register control device to the machine control. The more complex the control strategies are, the more process information that is required. The register control device therefore also requires an equally large number of actuator adjustments, which are performed during the process by the machine control. Communication of this type results in time delays, thereby limiting the dynamics of the register control.

Publication DE 10 2005 019 566 A1 describes a drive system for a printing press with several individually-drivable printing units that are equipped with longitudinal register adjustment devices. This drive system includes several measured value evaluation devices for adjusting the longitudinal register adjustment devices of all printing units located before or after a first printing unit, for correcting a register deviation on the first printing unit.

Previously, the register control device has calculated the correction variables for the register error. Register deviation is detected using sensors located directly behind the particular printing units, and it is forwarded to the register control device. Based on a control strategy, the register control device calculates the related manipulated variables. These manipulated variables must now be transferred to devices for machine control.

### ADVANTAGES OF THE INVENTION

The present invention relates to a method for operating a printing press, with which a control for at least one register and a control for at least one printing press module of the printing press are carried out jointly by an automation device.

In an embodiment of the method, the automation device controls a motion of the at least one printing press module. In this process, exact setpoint values, e.g., for the motion of the at least one printing press module, e.g., along a virtual master axis, may be generated.

The automation device makes it possible to control a sequence of a printing process. A module (SPS) of the automation device provided to monitor and, therefore, to regulate or control the process may trigger interfaces of the automation device, e.g., based on logical queries, via which correction values and/or time elements for the at least one printing press module may be exchanged via input and/or output.

In a variant of the method, a decoupled dynamic adjustment of printing press modules is carried out. In this case, only a first register is changed, and further registers for other printing press modules are decoupled from the correction procedure of the first register, in particular with consideration for dynamic time elements.

The inventive automation device is designed to interact with a printing press.

Functionalities are integrated in the automation device for controlling at least one printing press module and for register control.

The automation device typically includes a module and/or a device for monitoring and, therefore, controlling and/or regulating at least one printing press module and a device for monitoring and, therefore, controlling and/or regulating registers. The automation device is therefore suited, e.g., for controlling a motion of the at least one printing press module. In one variant, the automation device may be designed to calculate data for controlling the at least one printing press module, and for register control and/or regulation. The automation device may be used to control a process of the printing press.

The inventive printing press includes an inventive automation device.

The present invention also relates to a computer program with program code means to carry out all steps of an inventive method when the computer program is run on a computer or a related arithmetic unit, in particular in an inventive automation device.

The inventive computer program product with program code means, which are stored on a computer-readable data storage device, is suitable for carrying out all steps of an inventive method when this computer program is run on a computer or a related arithmetic unit, in particular on an inventive automation device.

The inventive automation device typically interacts with the inventive printing press or at least one printing press module. The inventive automation device may be designed as a component of the inventive printing press. All steps of the inventive method may be carried out by the inventive automation device and/or the inventive printing press. Functions of the inventive automation device and/or the inventive printing press may be realized as steps or sub-steps of the inventive method.

Using the inventive method, it is possible, e.g., to calculate adjustment motions and setpoint values using the integrated automation device, which may also specify and, therefore, control the motion of the at least one printing press module and, therefore, the printing press. It is therefore possible to eliminate an external register control device with complex communication interfaces.

The present invention makes it possible to optimize the register control and machine control in a gravure press, in particular an in-line flexo or commercial printing press or a newspaper roll printing press, in particular within the framework of controlling web tension and processing registers. It is possible to apply the present invention to printing and processing paper webs, textile webs, and, therefore, material webs in general.

This makes it possible to realize, e.g., an optimized control and decoupling of registers designed as processing registers, e.g., a color register, by integrating the functionalities for motion control and register control in the automation device.

The fact that a register control device and a machine control device were typically run separately resulted in several interfaces and more communication between the individual devices.

By combining the module for register control and a control module (motion control) designed to perform machine control for the at least one printing press module—which may include a module for controlling the motion of a process (SPS) of the at least one printing machine module—it is also possible to improve the decoupling of the register adjustment, since the correction values may also be calculated in the automation device like the parameters, e.g., time elements, for the machine control. The automation device also calculates a coupled dynamic adjustment of the impression cylinders for decoupling an impression cylinder adjustment on a printing press module designed as a printing unit. The automation device may perform the independent length adaptation while adjusting the dynamic time elements.

It is therefore possible to combine register control and machine control in the automation device, and decoupling variables for printing press modules may be calculated more easily. In addition, the automation device calculates a dynamic linked adjustment of the impression cylinders on a printing unit. Changes in length or incorrect length entries may result in incorrect dynamic time constants. It is therefore practical to monitor the lengths between printing units and, possibly, to calculate them, and to have the machine control of the automation device adjust the related time constants of the time elements independently.

A combination of the automation device with a human-machine interface (HMI) is also possible. The, e.g., dynamic adjustment to be carried out may be integrated with the HMI via a “soft” control by integrating the motion control and the HMI in a visualization/control device as a component of the automation device and/or the printing press.

As an alternative, the automation device may also include only one register control module and a module for the process control (SPS) and/or the motion control for realizing the motion control. Motion control may provide, e.g., dynamic manipulated variables for the decoupling when used to carry out key color control.

Using a motion logic control that controls the motion and machine process, if register deviations occur, the setpoint value for the register adjustment is calculated. Using dynamic time elements, the precontrol values are also calculated in the motion logic control and forwarded to the downstream printing press modules, such as printing units, web transport axes, drawing rollers, cooling rollers, or further processing axes, e.g., rewind axes, so that the register adjustment of a first printing press module is decoupled from the register adjustments for the other printing press modules. As a result of the decoupling, the controlled system of a printing unit is linearized and the control is greatly simplified. In the present description, a register error y (i, j) means that the register error between printing units i and j is being considered.

In an embodiment, adjustment is carried out relative to fixed key color, which is color 1 in this example, so that, when a register deviation occurs at impression cylinder 2, only register y (1, 2) changes, while registers y (1, 3), y (1, 4), etc., remain unchanged. This is carried out using weighted and unweighted dynamic time elements, i.e., proportional elements P, PT1, PT2, . . . , PTn, of differential elements DT1, . . . , DTn, Tt, integral elements IT1, . . . , ITn, and of all-pass elements. The key color control may be calculated downstream by the automation device and, therefore, for subsequent printing press modules, that is, e.g., a certain impression cylinder or an impression cylinder to be regulated, and all subsequent impression cylinders and/or drawing rollers are adjusted dynamically with different amplitudes and a different dynamic response of the time elements, e.g., P, PT1, PT2, . . . , PTn, DT1, . . . , DTn, Tt, IT1, . . . , ITn and all-pass elements. As an alternative or in addition thereto, it is also possible for the automation device to perform a calculation upstream for preceding printing press modules, i.e., the printing unit on which the register deviation occurs is not adjusted, but instead, all upstream printing units and/or all downstream printing units are adjusted dynamically with different amplitudes and a different dynamic response.

In a further embodiment, the machine control may combine dynamic and static couplings based on machine and/or material behavior. This applies, e.g., to friction, acceleration, and other factors that affect the motion of the printing process and/or its printing press modules. Due to printing press influences of this type, dynamic and static couplings may be combined with each other by the machine control by changing the factors, in order to compensate for these influences.

In one variant, as a component of the automation, the machine control may calculate a dynamic decoupling strategy with a combination between color/precursor color and key color control. This may take place if a change occurs during different production phases, e.g., an acceleration phase, a stationary printing process, and different productions. A change may be carried out within the automation device. In this case, e.g., the first colors are adjusted relative to a color/precursor color, since, in a gravure press, light colors are often printed first, and contrast problems may occur with the sensors. Adjustment is then carried out relative to the key color, e.g., from the mid-point onward. The machine control in the automation device may also calculate decoupling strategies when controlling any colors relative to each other, e.g., for y (1, 2), y (1, 3), y (2, 4), y (3, 5), etc.

With a possible method for operating a printing process designed as a web offset printing press, it may be provided that the register control is integrated in the machine control of the automation device, which therefore controls the motion and machine process, in addition to register control. A combination with a human-machine interface (HMI) of the printing press, e.g., a control station, may take place, the HMI of the register control being integrated in the printing press HMI.

A method of this type may be carried out via a “soft” control, integrated on a processor of a printing press HMI or the register control device HMI. In this case, the register control is carried out by a combination of register control and printing press process, or register control and motion control. The automation device may carry out a control-related decoupling of the printing press modules—which are designed as printing units—relative to a register error.

When the register adjustment is decoupled—a step that affects directly adjacent registers—the automation device may adjust each color relative to its precursor color y (1, 2), y (2, 3), . . . , y (i−1, i), y (i, i+1), . . . , y (n−1, n).

In a further embodiment, the automation device may decouple an adjustment of an impression cylinder i and an associated change of the register y (i−1, i) via the adjustment of the downstream printing units and, optionally, the web transport axes, drawing rollers, and further processing axes, in particular winding axes, while all other registers y (1, 2), . . . , y (i−2, i−1), y (i, i+1), y (i+1, i+2), . . . remain unchanged.

In a possible variant of the present invention, the automation device compensates for a register deviation on an impression cylinder i by adjusting the draw-in mechanism, further processing axes, e.g., rewind and unwind axes in particular, and all upstream impression cylinders 1, . . . , (i−1), and by adjusting all downstream impression cylinders i+1, . . . , n in such a manner that only register y (i−1, i) changes and all directly adjacent registers y (1, 2), . . . , y (i−2, i−1), y (i, i+1), y (i+1, i+2), . . . remain unchanged and are otherwise decoupled from the register change.

The decoupling of the register adjustment, which may be carried out by the automation device, may also take place on a key color s, that is, all registers are adjusted relative to a previously defined color. An adjustment of an impression cylinder i and an associated change of the register y (s, i) are decoupled via the adjustment of the downstream printing units, so that all other registers y (s, 2), . . . , y (s, i−1), y (s, i+1), y (s, i+2), remain unchanged.

In a variant of the method to be carried out by the automation device, a register deviation on an impression cylinder i is compensated for by adjusting the draw-in mechanism, further processing axes—in particular rewind and unwind axes—cooling rollers, and all upstream impression cylinders 1, . . . , i−1, and by adjusting all downstream impression cylinders i+1, . . . , n in such a manner that only register y (s, i) changes and all other registers y (s, 2), . . . , y (s, i−1), y (s, i+1), . . . remain unchanged relative to key color s, and they are decoupled from the register adjustment.

The adjustment of the related printing units may therefore take place in a dynamic manner. A dynamic co-adjustment of these printing units may take place in a weighted or unweighted manner via the dynamic time elements. The dynamic co-adjustment may also take place using a combination of several dynamic time elements and weighting elements. The intended dynamic time elements are preferably proportional elements PT1, . . . , PTn, differential elements DT1, . . . , DTn, and integral elements IT1, . . . , ITn, all-pass elements, or dead-time elements.

In a further embodiment, the decoupling may be carried out with a combination of key color and color/precursor color. The decoupling strategy may be changed from production to production and adjusted in a particularly suitable manner, so that the decoupling strategy, key color, and/or color/precursor color are changed, e.g., during the printing process. Using dynamic and static coupling, it is possible to react to production-specific features, such as the material to be printed on, temperature, humidity, web length, distance between printing units, and/or machine speed. An independent length adaptation and, as a result, an independent adjustment of the dynamic time elements may be carried out.

The parameters of the dynamic coupling with the machine speed may also be adapted. This may take place, e.g., in proportion to the reciprocals of the machine speed as a function of the length of the continuous material, and in proportion to the length of the continuous material in particular. Furthermore, the coupling parameters may be adapted to the type of material to be printed on, or to the width of the continuous material.

It is also possible for additional clamping points to be incorporated in the control strategy, e.g., via driven cooling rollers and/or driven transport rollers, and/or driven guide rollers. The automation device adapts the parameters regularly using fuzzy techniques, model-based techniques, e.g., model tracking control, observer techniques, or Kalman techniques.

A web press used in a realization of the method may be designed as a shaftless printing press with individual motors/drives, individual drives on the individual printing units, or web transport rollers or cooling rollers. A shaftless web press of this type drives the impression cylinder in the printing unit via individual drives. The impression cylinder, e.g., pressure roller, may be driven individually, or indirectly. The register control and a generation of the setpoint values of a virtual master axis for the printing press or the printing press module may be carried out, e.g., in an automation device. For example, register control signals may be applied to the setpoint values of a virtual master axis generated in the automation unit and, as a result, the setpoint values adjusted in this manner may be forwarded to the related printing press module. As a result, conditions are made more favorable for a simplified design and faster communication.

With known procedures or systems, several devices are required to calculate the manipulated variables for the register control and the machine motion, machine control, machine HMI, register control, and HMI of the register control or the register controller. This results in higher hardware costs, and greater effort for start-up, maintenance, and installation. An additional HMI is usually required for register control, i.e., an additional service computer. In addition, only static decoupling strategies are used to calculate the manipulated variables to compensate for the register error. The control strategies used are often not complex enough.

Further advantages and embodiments of the present invention result from the description and the attached drawing.

It is understood that the features mentioned above and to be described below may be used not only in the combination described, but also in other combinations or alone without leaving the framework of the present invention.

### EXEMPLARY EMBODIMENT

The present invention is depicted schematically with reference to exemplary embodiments in the drawing, and it is described in detail below with reference to the drawing.

### DESCRIPTION OF THE FIGURES

FIG. 1 shows a schematic, detailed depiction of an embodiment of a printing press that includes a preferred exemplary embodiment of an automation device.

FIG. 2 is a diagram that illustrates the decoupling of the register correction when key color scanning is carried out after a printing unit has been adjusted, according to an embodiment of the inventive method.

### DETAILED DESCRIPTION OF THE FIGURES

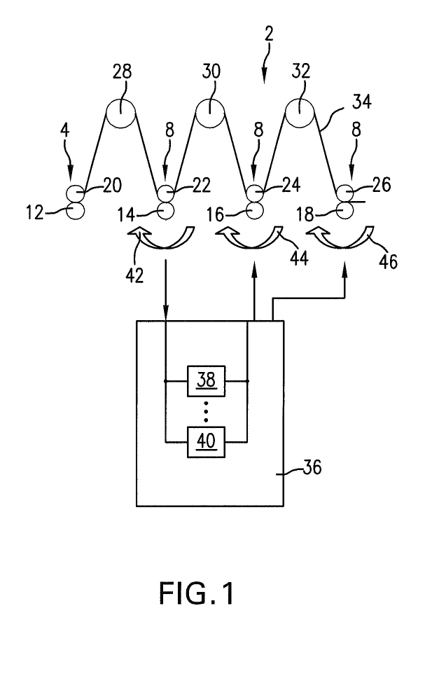

The detained view of an embodiment of an inventive printing press 2 shown schematically in FIG. 1 includes a first, second, third, and fourth printing unit 4, 6, 8, 10, each with an impression cylinder 12, 14, 16, 18 and a pressure roller 20, 22, 24, 26, which interacts with impression cylinder 12, 14, 16, 18. This printing press also includes carrier rollers and/or cooling rollers 28, 30, 32. A material web 34 to be printed on moves between impression cylinders 12, 14, 16, 18 and pressure rollers 20, 22, 24, 26, and wraps around carrier rollers and/or cooling rollers 28, 30, 32.

Printing press 2 also includes an embodiment of an inventive automation device 36 designed to monitor and, therefore, to control and/or regulate the register of material web 34 and at least one printing press module of printing press 2, i.e., in this case, at least one impression cylinder 12, 14, 16, 18, pressure roller 20, 22, 24, 26, and/or at least one carrier roller 28, 30, 32. Via a control of this type, it is possible to also change and/or correct motions of the at least one printing press module and the register.

When key color scanning is carried out, in the downstream mode, a register deviation on printing unit 6 is sent to automation device 36. Automation device 36 calculates the particular setpoint values for the precontrol of downstream printing units 8, 10 using dynamic time elements 38, 40, their combination, and different amplitudes, and forwards these setpoint values to downstream printing units 8, 10.

The result, therefore, is that the functionalities for controlling the printing press modules and, therefore, printing press 2 and, in particular, for performing motion control of printing press 2 and register control are integrated, as a measure for performing register control in automation device 36. An integration of this type may possibly take place in combination with and/or using a printing press and register control HMI. It is therefore possible to reduce the number of interfaces and the amount of communication required. Eliminating communication transit times increases the control dynamics.

A decoupled dynamic adjustment of the printing press module is also attained using the embodiment of the method described with reference to FIG. 1. In this procedure, only a first register is adjusted. Further registers are decoupled from each other by coupling correction values 42, 44, 46—which are values for angle corrections in this case—with consideration for time elements 38, 40 for the printing press modules, e.g., printing units 4, 6, 8, 10 and their components.

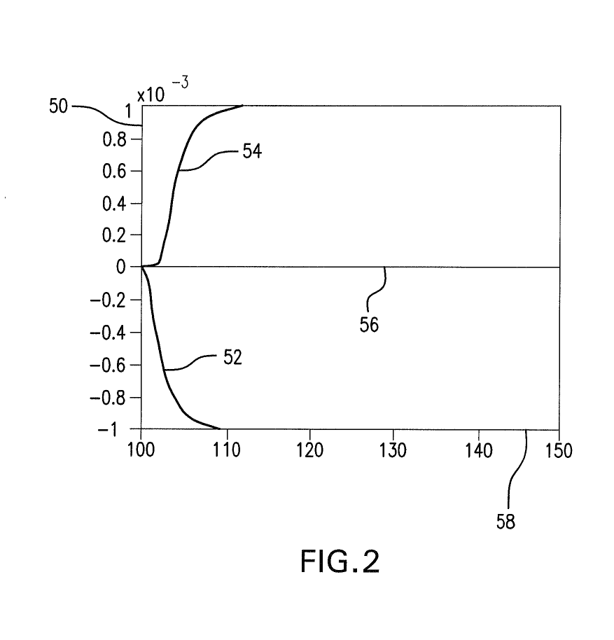

FIG. 2 shows a diagram with an axis 50 for correction values for register errors for plots 52, 54, 56 of individual registers y (1, 2), y (2, 3), y (1, 4), which are plotted on a time axis 58.

The figure shows an example of decoupling the actuating motion based on the dynamic precontrol values calculated by the automation device. The result is that register y (1, 2) changes as desired, while the other registers y (1, 3), y (1, 4), which are taken into consideration when key color scanning is performed, remain unchanged, i.e., they are decoupled from the adjustment.

As an alternative, it is also possible for the automation device to perform a calculation upstream, i.e., the printing unit on which the register deviation occurs is not adjusted, but instead, all upstream printing units and the draw-in mechanism, and all downstream printing units are adjusted dynamically with different amplitudes and a different dynamic response.

As an alternative or in addition thereto, the automation device may calculate dynamic manipulated variables for the decoupling when color/precursor color control is performed. This takes place using a motion logic control of the automation device, which controls the motion and the machine process. To this end, when register deviations occur, the setpoint value for the register adjustment is calculated.

Using dynamic time elements, the precontrol values are also calculated in the motion logic control of the automation device and forwarded to the downstream printing units and, therefore printing press modules, thereby decoupling the register adjustments of the printing units. Adjustment is therefore carried out relative to the color/precursor color, so that, when a register deviation occurs at the second impression cylinder, only register y (1, 2) changes, while registers y (2, 3), y (3, 4), etc., remain unchanged. This is carried out using weighted and unweighted dynamic time elements, e.g., proportional time elements P, PT1, PT2, . . . , PTn, differential elements DT1, . . . , OTn, Tt, integral time elements IT1, . . . , ITn, and all-pass elements.

The color/precursor color control may be calculated, e.g., downstream by the automation device, i.e., the impression cylinder itself and all downstream rollers, such as impression cylinders, drawing rollers, cooling rollers, web transport rollers, and further processing axes, e.g., winding rollers, are adjusted dynamically with different amplitudes and a different dynamic response, e.g., P, PT1, PT2, . . . , PTn, DT1, . . . , DTn, Tt, IT1, . . . , ITn and all-pass elements.

It is also possible for the automation device to calculate the color/precursor color control upstream, i.e., the printing unit on which the register deviation occurs is not adjusted, but instead, all upstream printing units and the draw-in mechanism, and all downstream printing units are adjusted dynamically with different amplitudes and a different dynamic response.

### REFERENCE NUMERALS

2 Printing press

4, 6, 8, 10 Printing unit

12, 14, 16, 18 Impression cylinder

20, 22, 24, 26 Pressure roller

28, 30, 32 Carrier roller and/or cooling roller

34 Material web

36 Automation device

42, 44, 46 Correction values

50 Axis

52, 54, 56 Plots

58 Master axis

What is claimed is:

1. A method for operating a printing press (2), with which a control for at least one register and a control for at least one printing press module of the printing press (2) are carried out jointly by an automation device (36).

2. The method as recited in claim 1, with which the automation device (36) controls a motion of the at least one printing press module.

3. The method as recited in claim 2, with which the setpoint values for the motion of the at least one printing press module are generated.

4. The method as recited in claim 1, with which the automation device (36) controls a printing process.

5. The method as recited in claim 1, with which a decoupled dynamic adjustment of printing press modules is carried out.

6. The method as recited in claim 1, with which only a first register is changed, and further registers for other printing press modules are decoupled from a dynamic adjustment by coupling correction values (42, 44, 46), in particular with consideration for dynamic time constants (38, 40).

7. An automation device designed to interact with a printing press (2), with functionalities being integrated in the automation device (36) for controlling at least one printing press module and for register control.

8. The automation device as recited in claim 7, that includes a device for controlling at least one printing press module and a device for register control.

9. The automation device as recited in claim 7, that is designed to control a motion of the at least one printing press module.

10. The automation device as recited in claim 7, that is designed to calculate data for controlling the at least one printing press module and for register control.

11. The automation device as recited in claim 7, that is designed to control a process of the printing press (2).

12. A printing press that includes an automation device as recited in claim 7.

13. A computer program with program code means, to carry out all steps of a method as recited in claim 1 when the computer program is run on a computer or a related arithmetic unit, in particular in an automation device (36).

14. A computer program product with program code means stored on a computer-readable data storage device, to carry out all steps of a method as recited in claim 1 when the computer program is run on a computer or a related arithmetic unit, in particular in an automation device (36).
